(19) United States
(12) Patent Application Publication
(10) Pub. No.: US 2011/0214571 A1
(43) Pub. Date: Sep. 8, 2011

(54) DEGASSER WITH VENT IN VACUUM CHAMBER

(75) Inventor: Manfred Berndt, Waldbronn (DE)

(73) Assignee: AGILENT TECHNOLOGIES, INC., Santa Clara, CA (US)

(21) Appl. No.: 13/122,808

(22) PCT Filed: Oct. 20, 2008
(86) PCT No.: PCT/EP2008/064135

§ 371 Date: Apr. 6, 2011

(51) Int. Cl. B01D 19/00

(52) U.S. Cl. 96/6; 96/193; 96/154; 96/174

(57) ABSTRACT

A degassing apparatus (27) for degassing a liquid (240) comprises a vacuum chamber (200), a liquid conveyance member (210) disposed in the vacuum chamber (200) and adapted for transporting the liquid (240), and a pump (220) adapted to evacuate the vacuum chamber (200). The vacuum chamber (200) comprises a vent (270) adapted for venting the vacuum chamber (200).

### BACKGROUND ART

The present invention relates to a degasser, in particular in a high performance liquid chromatography application.

In high performance liquid chromatography (HPLC, see e.g. http://en.wikipedia.org/wiki/HPLC), a liquid has to be provided usually at a very controlled flow rate (e. g. in the range of microliters to milliliters per minute) and at high pressure (typically 20-100 MPa, 200-1000 bar, and beyond up to currently 200 MPa, 2000 bar) at which compressibility of the liquid becomes noticeable. For liquid separation in an HPLC system, a mobile phase comprising a sample fluid with compounds to be separated is driven through a stationary phase (such as a chromatographic column), thus separating different compounds of the sample fluid.

Degassing of liquid solvents is often required for HPLC applications as the presence of even small amounts of dissolved gases can interfere with the accuracy and sensitivity of the results obtained. Moreover, if the dissolved species is chemically active, as in the case of oxygen and air, such species can additionally produce unwanted changes or deterioration in the mobile phase itself.

Degasification in general is the removal of dissolved gases from liquids, especially water or aqueous solutions, in the fields of science and engineering. There are numerous possible methods for such removal of gases. The solubility of gas obeys Henry's law, that is, the amount of a dissolved gas in a liquid is proportional to its partial pressure. Therefore, placing a solution under reduced pressure (vacuum) makes the dissolved gas less soluble. This technique is often referred to as vacuum degasification. Specialized vacuum chambers, called vacuum degassers, are used to degas materials through pressure reduction.

U.S. 2007/261553 A1 discloses a so-called tubing-type vacuum degassing apparatus having a pump for evacuating a vacuum chamber. A tubing as a liquid conveyance member is disposed in the vacuum chamber and adapted for transporting the liquid. One or more pumping cavities are in fluid communication with the vacuum chamber, and a continuous vent channel that has an outlet disposed in fluid communication with a respective one of the one or more pumping cavities. The vent channel is configured to provide dilution gas flow into the pumping cavity of the pump at a rate sufficient to prevent solvent condensation in the pumping cavity during operation of the pump in liquid degassing applications.

So-called membrane-type vacuum degassing apparatuses are described e.g. in U.S. Pat. No. 5,693,122 A, U.S. Pat. No. 6,258,154 B1, and U.S. Pat. No. 6,355,134 B1, all by the same applicant. The degasser comprises a cavity through which liquid is conducted, with gas being removed from the liquid through at least one of the limiting faces of the cavity by providing on the side of the face distal to the cavity a smaller pressure than within the cavity. The limiting face between the cavity and the region having reduced pressure compared to the cavity is formed by at least one thin membrane, having a thickness e.g. of less than about 10 micrometers. A porous support structure for supporting the membrane is provided. The degasser can be miniaturized and integrated into a liquid chromatograph.

To effectuate the evacuation of the enclosed chamber of a vacuum degassing apparatus, pumps are typically employed in operable connection with such vacuum chambers. Various pump types may be utilized. Single or multiple-stage positive-displacement pumps are well suited to create and maintain a desired level of reduced pressure within the vacuum degassing chamber.

One issue that arises in vacuum degassing applications is the presence of solvent vapor from the degassing vacuum chamber as a result of permeation of such solvent vapors through the semi-permeable membrane wall disposed in the chamber. If the concentration of the solvent vapor reaches a critical level, solvent condensation may occur, leading to operational and durability problems e.g. of the pump. For example, condensed solvent may cause a pump to “choke” and may also cause corrosion of metallic parts in the pump.

To minimize the likelihood of solvent vapor condensation within the pump, “flow restrictors” have been utilized to allow a small amount of air external to the pump to enter into, for example, the compression chambers of the pump so as to dilute the solvent vapor concentration below a critical condensation point. The vent flow rate of air required to avoid such solvent condensation depends upon the solvent vapor pressure at the pump operating temperature, as well as the solvent permeability through the semi-permeable membrane utilized in the degassing operations in the vacuum chamber. Solvent permeability is unique for each solvent, and the solvent permeation rate approaches zero in situations where the solvent partial pressure inside the vacuum chamber is equal to the solvent vapor pressure at the chamber temperature. Under static flow conditions with the total chamber pressure below solvent vapor pressure, the partial pressure of solvent inside the chamber is equal to the total pressure. Under dynamic flow conditions, however, the amount of solvent permeating the membrane increases due to the introduction of entrained air into the chamber that reduces the solvent partial vapor pressure within the vacuum chamber.

Conventional vacuum pumps utilized in liquid degassing applications have commonly employed sintered porous frits as flow restrictors to control the infiltrating vent gas flow rate. An example of such a pump arrangement is shown and described in U.S. Pat. No. 6,494,938 B2. Such sintered porous frits present operational drawbacks and the potential for degradation over time. In particular, many of such sintered porous frits are fabricated from materials that are susceptible to corrosion from certain solvents and additives utilized in, for example, liquid chromatography mobile phases. Moreover, the sintered porous frits commonly utilized in vacuum degassing applications contain pore sizes on the order of less than 1 μm. Due to the small size of the frit pores, particles may become lodged within the pores, thereby blocking or reducing vent gas passage therethrough. The small pore size can also lead to solvent vapor condensation within the pores, which can cause vent gas restriction and/or vapor condensation within the pumping cavities. In addition, such sintered porous frits are relatively expensive.

The aforementioned U.S. 2007/261553 A1 provides venting of the pumping cavity of the pump, thus enabling controlled vent gas influx into the pump and allowing to avoid the use of sintered porous frits manufactured of corrosion-susceptible material and/or those having mean pore sizes of less than 1 μm.

In the Agilent 1200 Series Vacuum Degasser and Micro Vacuum Degasser, product number G1379B (see Agilent 1200 Series Micro Vacuum Degasser Reference Manual, Publication Number: G1379-90010), as provided by the applicant Agilent Technologies, control of the vacuum level and venting is provided by means of a controllable orifice situated in the connection between the vacuum pump and one or more the vacuum chambers.

### DISCLOSURE

It is an object of the invention to provide an improved degasser in particular for HPLC applications. The object is solved by the independent claim(s). Further embodiments are shown by the dependent claim(s).

According to the present invention, a degassing apparatus for degassing a liquid comprises a vacuum chamber, a liquid conveyance, and a pump. The liquid conveyance member is disposed in the vacuum chamber and configured for transporting the liquid (at least through the vacuum chamber). The pump is provided and adapted for evacuating the vacuum chamber. The vacuum chamber comprises a vent adapted for (directly) venting the vacuum chamber.

Providing the vent into the vacuum chamber allows directly venting the vacuum chamber and thus preventing or at least reducing solvent condensation in the vacuum chamber (in particular during operation of the degassing apparatus). It has been found that solvent condensation, e.g. at inner walls of the vacuum chamber, can lead to dissolving of substances from such walls and into the solvent with the effect that such dissolved substances may then diffuse through the liquid conveyance member and into the liquid. This, again, can lead to impurities into the liquid which might adversely affect measuring results, e.g. in case the degassing apparatus is used for degassing a mobile phase in an HPLC system. Such impurities may become visible e.g. as one or more peaks in a chromatogram and thus reduce measurement accuracy or even lead to wrong measurement results. By avoiding or at least reducing solvent condensation in the vacuum chamber, such impurities can also be avoided or at least reduced.

With the direct venting of the vacuum chamber, the invention allows to use types of liquid conveyance members even having a higher liquid evaporation rate. It has been shown by applicant (and will be illustrated later in greater detail), that certain materials and/or forms of the liquid conveyance member exhibit a larger evaporation rate of liquid into the vacuum chamber, which evaporation rate also shows a dependency on the solvent type (as the liquid to be transported by the liquid conveyance member). For example, n-hexane exhibits a significantly higher evaporation rate than acetonitrile, which again evaporates much easier than water.

It has further been shown that such material used as liquid conveyance member and showing a higher suitability for degassing liquid typically also shows a higher liquid evaporation rate. In other words, materials showing a higher performance for degassing often also show a higher liquid evaporation rate. Apparently, as more efficient the liquid conveyance member material is for degassing, the higher also the (unwanted) liquid evaporation rate into the vacuum chamber becomes. By means of the direct vent of the vacuum chamber, the invention allows using such higher degassing performance materials, whereby the effect of impurities (e.g. from materials used in the vacuum chamber) can be reduced or even be eliminated.

In embodiments the vent can comprise or be provided by an orifice, a membrane, a vent channel, or a combination thereof. Such vent channel might be comprised of a tube, a capillary, and/or a microstructure. Such embodiments allow a simple configuration of the vent.

The vent is preferably designed so that a venting flow through the vent into the vacuum chamber is or can be adjusted to a pumping characteristic of the pump, e.g., in a way that the pump can maintain a given or settable vacuum level in the vacuum chamber. For example, when the degassing apparatus is operated in a normal operation mode (e.g. after an initial setup phase to bring the vacuum chamber from normal—e.g. ambient—condition to vacuum), adjusting the venting flow to a pumping rate of the pump allows maintaining a substantially constant vacuum level in the vacuum chamber.

The vent is preferably configured to provide a venting flow (also referred to as dilution gas flow) into the vacuum chamber at a rate sufficient to prevent or at least reduce solvent condensation in the vacuum chamber during operation of the degassing apparatus. The reduction of solvent condensation allows reducing impurities into the liquid resulting from such condensation, thus leading e.g. to a higher measurement accuracy. Further, even materials having a higher liquid evaporation rate into the vacuum chamber can be used for the liquid conveyance member.

The vent might further comprise a filter for filtering the venting flow through the vent into the vacuum chamber. Such filtering might further reduce impurities or contamination resulting from the venting flow into the vacuum chamber.

The filter can be disposed at an inlet of the vent. The filter might comprise a sintered porous frit which might have a minimum pore size of about ten micrometer. In another embodiment the filter comprises activated carbon, a membrane, a microstructure, and/or a sieve. Such filter material might be used individually or in combination, for example, in a layered structure.

In one embodiment, the vent is provided by the filter, i.e. the filter is situated at an inlet into the vacuum chamber.

The filter can be detachably coupled to the degassing apparatus and might be configured as a replaceable part, so that one filter can be replaced by another. Rather than replacing the entire filter, the filter might be configured comprising a replaceable filtering part, so that only such filtering part needs to be replaced. Preferably the filter can be detachably coupled using a luer fitting mechanism to ensure proper tightness.

An outlet of the vent as well as a pump outlet can be situated into the vacuum chamber. In such embodiment, the pump is coupled to such pump outlet for evacuating the vacuum chamber. In one embodiment, the outlet of the vent is situated adjacent to the pump outlet for achieving a suitable vent flow through the vacuum chamber. However, the position of the vent in the vacuum chamber might not be critical in many applications, in particular at vacuum levels of and below 100 mbar, as long as there is a continuous vent flow.

In order to sense a value of pressure in the degassing apparatus, a sensor (e.g. a pressure sensor) can be provided. The sensor is preferably situated into the vacuum chamber but might also be located coupling to the vacuum chamber, such as in a coupling between the pump and the vacuum chamber or any other conveyance coupling into the vacuum chamber.

A control unit might be coupled to the vent and/or the pump for controlling operation of the vent and/or the pump. In particular, the control unit might control a pressure in the vacuum chamber by controlling operation of the vent and/or the pump. Preferably, the control unit might control the pressure in the vacuum chamber to a given or settable vacuum level, which might be a defined pressure value and/or a pressure range.

The liquid conveyance member might comprise a tubing defining a lumen for containing and transporting the liquid. This represents the tubing-type vacuum degassing apparatus as described in the introductory part of the description. Alternatively or in combination, the liquid conveyance member might comprise a cavity for containing a transporting the liquid. A membrane of the liquid conveyance member is facing towards the vacuum chamber. Such embodiment represents the membrane-type vacuum degassing apparatus as also described in the introductory part of the description.

The term “vacuum” as used herein shall generally relate to a pressure lower than ambient, in particular to a pressure in the range of 1-50 kPa (10-500 mBar), and preferably of about 10 kPa (100 mBar).

Beyond the vent provided in the vacuum chamber, embodiments of the degassing apparatus might comprise further venting, as known in the art, in particular as laid out in the introductory part of the description. Such further venting might be provided in the pump and/or any conveyance, connection or other coupling to the vacuum chamber.

The degassing apparatus is preferably applied in a fluid separation system for separating compounds of a sample fluid in a mobile phase. The fluid separation system comprises a mobile phase drive, such as a pumping system, for driving the mobile phase through the fluid separation system. The degassing apparatus is provided for degassing the mobile phase, preferably before the sample fluid is introduced into the mobile phase. A separation unit, which might be a chromatographic column, is provided for separating compounds of the sample fluid in the mobile phase. Such fluid separation system is preferably an HPLC system.

Embodiments of the present invention might be embodied based on most conventionally available HPLC systems, such as the Agilent 1200 Series Rapid Resolution LC system or the Agilent 1100 HPLC series (both provided by the applicant Agilent Technologies—see www.agilent.com—which shall be incorporated herein by reference).

One embodiment comprises a pumping apparatus having a piston for reciprocation in a pump working chamber to compress liquid in the pump working chamber to a high pressure at which compressibility of the liquid becomes noticeable.

One embodiment comprises two pumping apparatuses coupled either in a serial or parallel manner. In the serial manner, as disclosed in EP 309596 A1, an outlet of the first pumping apparatus is coupled to an inlet of the second pumping apparatus, and an outlet of the second pumping apparatus provides an outlet of the pump. In the parallel manner, an inlet of the first pumping apparatus is coupled to an inlet of the second pumping apparatus, and an outlet of the first pumping apparatus is coupled to an outlet of the second pumping apparatus, thus providing an outlet of the pump. In either case, a liquid outlet of the first pumping apparatus is phase shifted, preferably essentially 180 degrees, with respect to a liquid outlet of the second pumping apparatus, so that only one pumping apparatus is supplying into the system while the other is intaking liquid (e.g. from the supply), thus allowing to provide a continuous flow at the output. However, it is clear that also both pumping apparatuses might be operated in parallel (i.e. concurrently), at least during certain transitional phases e.g. to provide a smooth(er) transition of the pumping cycles between the pumping apparatuses. The phase shifting might be varied in order to compensate pulsation in the flow of liquid as resulting from the compressibility of the liquid. It is also known to use three piston pumps having about 120 degrees phase shift.

The separating device preferably comprises a chromatographic column (see e.g. http://en.wikipedia.org/wiki/Column chromatography) providing the stationary phase. The column might be a glass or steel tube (e.g. with a diameter from 50 μm to 5 mm and a length of 1 cm to 1 m) or a microfluidic column (as disclosed e.g. in EP 1577012 or the Agilent 1200 Series HPLC-Chip/MS System provided by the applicant Agilent Technologies, see e.g. http://www.chem.agilent.com/Scripts/PDS.asp?lPage=38308). For example, a slurry can be prepared with a powder of the stationary phase and then poured and pressed into the column. The individual components are retained by the stationary phase differently and separate from each other while they are propagating at different speeds through the column with the eluent. At the end of the column they elute one at a time. During the entire chromatography process the eluent might be also collected in a series of fractions. The stationary phase or adsorbent in column chromatography usually is a solid material. The most common stationary phase for column chromatography is silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface, though in EBA a fluidized bed is used.

The mobile phase (or eluent) can be either a pure solvent or a mixture of different solvents. It can be chosen e.g. to minimize the retention of the compounds of interest and/or the amount of mobile phase to run the chromatography. The mobile phase can also been chosen so that the different compounds can be separated effectively. The mobile phase might comprise an organic solvent like e.g. methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid might comprise any type of process liquid, natural sample like juice, body fluids like plasma or it may be the result of a reaction like from a fermentation broth.

The pressure in the mobile phase might range from 2-200 MPa (20 to 2000 bar), in particular 10-150 MPa (100 to 1500 bar), and more particular 50-120 MPa (500 to 1200 bar).

The HPLC system might further comprise a sampling unit for introducing the sample fluid into the mobile phase stream, a detector for detecting separated compounds of the sample fluid, a fractionating unit for outputting separated compounds of the sample fluid, or any combination thereof. Further details of HPLC system are disclosed with respect to the Agilent 1200 Series Rapid Resolution LC system or the Agilent 1100 HPLC series, both provided by the applicant Agilent Technologies, under www.agilent.com which shall be in cooperated herein by reference.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied in or by the control unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a liquid separation system 10, in accordance with embodiments of the present invention, e.g. used in high performance liquid chromatography (HPLC).

FIG. 2 shows a tubing-type vacuum degassing apparatus 27 according to an embodiment of the present invention.

FIG. 3 shows a membrane-type vacuum degassing apparatus 27 according to an embodiment of the present invention.

FIG. 4 illustrates the evaporation characteristics for different materials and solvents.

Referring now in greater detail to the drawings, FIG. 1 depicts a general schematic of a liquid separation system 10. A pump 20 receives a mobile phase from a solvent supply 25, typically via a degasser 27, which degases and thus reduces the amount of dissolved gases in the mobile phase. The pump 20—as a mobile phase drive—drives the mobile phase through a separating device 30 (such as a chromatographic column) comprising a stationary phase. A sampling unit 40 can be provided between the pump 20 and the separating device 30 in order to subject or add (often referred to as sample introduction) a sample fluid into the mobile phase. The stationary phase of the separating device 30 is adapted for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing might be a low pressure mixing and provided upstream of the pump 20, so that the pump 20 already receives and pumps the mixed solvents as the mobile phase. Alternatively, the pump 20 might be comprised of plural individual pumping units, with plural of the pumping units each receiving and pumping a different solvent or mixture, so that the mixing of the mobile phase (as received by the separating device 30) occurs at high pressure and downstream of the pump 20 (or as part thereof). The composition (mixture) of the mobile phase may be kept constant over time, the so called isocratic mode, or varied over time, the so called gradient mode.

A data processing unit 70, which can be a conventional PC or workstation, might be coupled (as indicated by the dotted arrows) to one or more of the devices in the liquid separation system 10 in order to receive information and/or control operation. For example, the data processing unit 70 might control operation of the pump 20 (e.g. setting control parameters) and receive therefrom information regarding the actual working conditions (such as output pressure, flow rate, etc. at an outlet of the pump). The data processing unit 70 might also control operation of the solvent supply 25 (e.g. setting the solvent/s or solvent mixture to be supplied) and/or the degasser 27 (e.g. setting control parameters such as vacuum level) and might receive therefrom information regarding the actual working conditions (such as solvent composition supplied over time, flow rate, vacuum level, etc.). The data processing unit 70 might further control operation of the sampling unit 40 (e.g. controlling sample injection or synchronization sample injection with operating conditions of the pump 20). The separating device 30 might also be controlled by the data processing unit 70 (e.g. selecting a specific flow path or column, setting operation temperature, etc.), and send—in return—information (e.g. operating conditions) to the data processing unit 70. Accordingly, the detector 50 might be controlled by the data processing unit 70 (e.g. with respect to spectral or wavelength settings, setting time constants, start/stop data acquisition), and send information (e.g. about the detected sample compounds) to the data processing unit 70. The data processing unit 70 might also control operation of the fractionating unit 60 (e.g. in conjunction with data received from the detector 50) and provides data back.

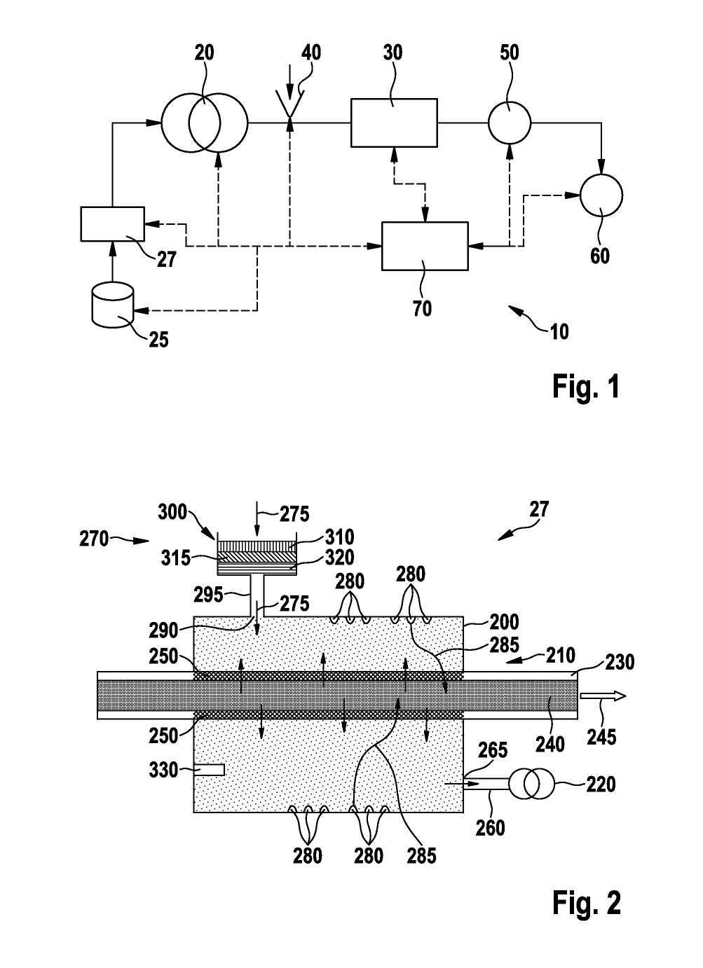

In the schematic diagram of FIG. 2 showing an embodiment of a tubing-type vacuum degassing apparatus 27, the degassing apparatus 27 comprises a vacuum chamber 200, a liquid conveyance member 210, and a pump 220. In the embodiment of FIG. 2, the liquid conveyance member 210 is embodied as a tube having an outer wall 230 and is adapted for transporting a liquid 240, which either already is the mobile phase of FIG. 1 or will be mixed with another solvent in order to provide the mobile phase. The flow direction of the liquid 240 is indicated by arrow 245.

The liquid conveyance member 210 (or at least a part thereof as indicated in FIG. 2) is disposed in the vacuum chamber 200. In order to allow gases solved in the liquid 240 to degas into the vacuum chamber 200, at least a portion 250 of the outer wall 230 is provided to be permeable for gases, thus allowing gases to dissolve from the liquid 240 and move into the vacuum chamber 200 as indicated by the (vertical) arrows traversing the permeable region 250. Either only a portion and preferably the entire portion of the outer wall 230 disposed in the vacuum chamber shall be embodied as the permeable region 250, such as Expanded PTFE-film e.g. Goretex.

The pump 220 is coupled via a pump conveyance 260 to a pump outlet 265 of the vacuum chamber 200, in order to evacuate the vacuum chamber 200 (as indicated by the arrow from the vacuum chamber 200 into the pump conveyance 260 symbolizing the gas flow).

The degassing apparatus 27 further comprises a vent 270 into the vacuum chamber 200. The vent 270 provides a venting flow into the vacuum chamber 200, as indicated by the two arrows 275, in order to prevent or at least reduce solvent condensation in the vacuum chamber 200.

In operation, the pump 220 evacuates the vacuum chamber 200 by providing a substantially continuous pump flow out of the vacuum chamber 200. In a preferred embodiment, the pump 220 maintains a pressure in the vacuum chamber 200 in the range of 1-50 kPa, and preferably about 10 kPa. Under the influence of the vacuum in the vacuum chamber 200, gases solved in the liquid 240 can dissolve and migrate through the permeable region 250 into the vacuum chamber 200, as indicated by the (vertical) arrows traversing the permeable region 250. However, in addition to the dissolved gases, a certain amount of the liquid 240 will also migrate through the permeable region 250 into the vacuum chamber 200 and might condensate anywhere within the vacuum chamber 200 as indicated by drops 280 representing solvent condensation at an outer wall of the vacuum chamber 200. Such solvent condensation 200 may solve substances (e.g. from the walls or any other material within the vacuum chamber 200). Such solved-out substances might then diffuse into the liquid 240 as indicated by arrows 285. Such dissolved substances 285 diffusing into the liquid 240 may represent impurities of the liquid 240. The invention prevents or at least reduces the solvent condensation 280 and may thus also prevent or at least reduce such impurities 285.

In the exemplary embodiment of FIG. 2, the vent 270 is provided by an orifice 290 which also provides an outlet of the vent into the vacuum chamber 200. A vent channel 295 might be coupled to orifice 290. The vent channel 295 might a tube, a capillary or any other suitable component.

Further in the embodiment of FIG. 2, the vent 270 might comprise a filter 300 for filtering the venting flow 275 into the vacuum chamber 200. In this embodiment, the filter 300 is comprised of a layer-type arrangement, e.g. with one or more layers of an activated carbon filter 310, a filter membrane 315, and a microstructure and/or sieve 320. However, it is clear that any other suitable configuration for the filter 300 can be applied accordingly.

Further in the embodiment of FIG. 2, the filter 300 is configured as a replaceable part so that e.g. the layered structure 310-320 only or the entire filter 300 can be replaced.

While the outlet 290 of the vent 270 into the vacuum chamber 200 as well as the pump outlet 265 may be situated anywhere in the vacuum chamber 200 allowing to suitably vent the vacuum chamber 200, the pump outlet 265 and the vent outlet 290 in the embodiment of FIG. 2 are located at neighboring walls of the vacuum chamber 200, and preferably around corners.

A sensor 330 is further located in the vacuum chamber 200 in order to sense a value of pressure in the vacuum chamber 200. However, rather than situating the sensor 330 directly in the vacuum chamber 200, the sensor 330 might also be located anywhere coupling to the vacuum chamber, e.g. in the pump conveyance 260. Further, the sensor 330 might be coupled to the control unit 70 (see FIG. 1) thus allowing the control unit 70 to control the pressure in the vacuum chamber 200 e.g. by controlling either one of the venting flow 275 of the vent 270 and the operation of the pump 220 or by controlling both. For that purpose, the control unit 70 needs to be coupled to the vent 270 and/or the pump 220.

Further details about the tubing-type vacuum degassing apparatus 27 are described in the documents cited in the introductory part of the description, and the teaching thereof with respect to the tubing-type vacuum degassing apparatuses shall be incorporated herein by reference.

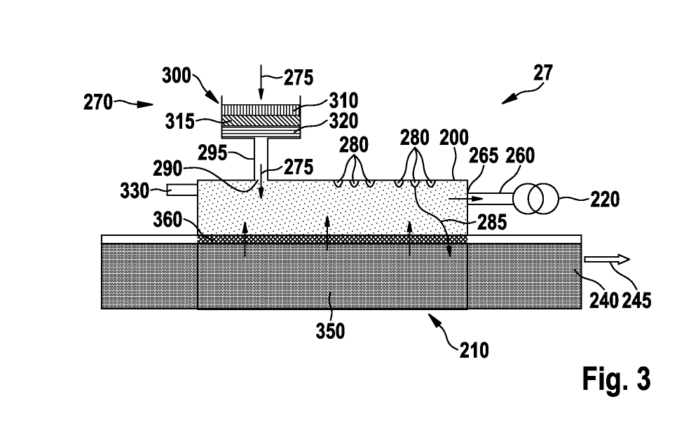

FIG. 3 illustrates in a schematic diagram an example of a membrane-type vacuum degassing apparatus 27, which substantially corresponds to the tubing-type vacuum degassing apparatus 27 of FIG. 2. Main difference is that instead of the tube 210 the liquid conveyance member 210 of FIG. 3 now comprises a cavity 350 having a membrane 360 towards the vacuum chamber 200. In operation, the cavity 350 is filled with the liquid 240, and under the influence of the vacuum in the vacuum chamber 200 gaseous components solved in the liquid 240 as well as a certain amount of the liquid itself migrates through the permeable membrane 360 into the vacuum chamber 200. The afore said with respect to FIG. 2 also applies here accordingly and doesn't need be repeated. Further details about the membrane-type vacuum degassing apparatus 27 are described in the documents as cited in the introductory part of the description and the teaching thereof with respect to such membrane-type vacuum degassing apparatuses shall be incorporated herein by reference.

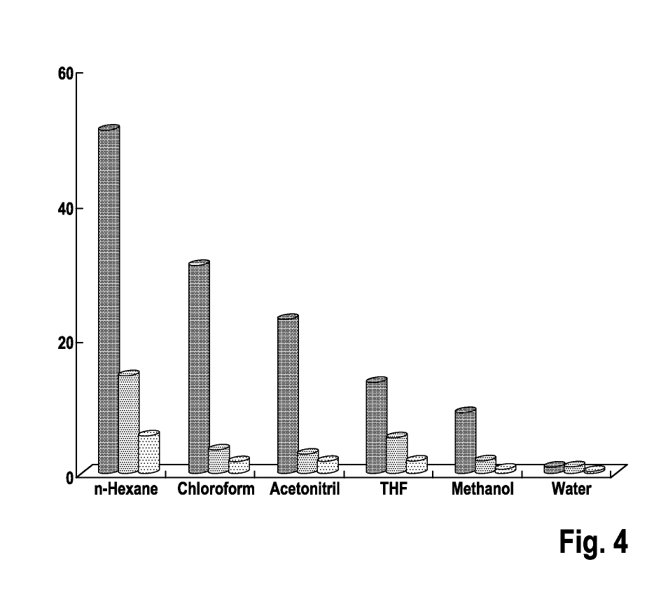

FIG. 4 illustrates examples of an evaporation characteristic for different types of the permeable region 250 or 360 as well as with respect to different types of solvents as the liquid 240. For each type of solvent, a measured evaporation rate is depicted for three different types of material of the permeable region 250, 360. The left bar (for each solvent) represents a Teflon AF material, whereas the middle and the right bar represent PTFE materials however with different thicknesses. The ordinate in the diagram of FIG. 4 depicts the evaporation rate measured e.g. in microliters per hour.

From FIG. 4 it becomes apparent, that different solvents may show a significantly different evaporation rate. For example, n-hexane exhibits an evaporation rate of more than twice of acetonitrile, which again shows about twice the evaporation rate of methanol. The lowest evaporation rate shows water.

Beyond the different evaporation rate for different solvents, the evaporation rate also significantly differs for the different materials. As the performance for degassing for the materials depicted in FIG. 4 also corresponds to the evaporation rate, it becomes apparent that more efficient materials can also lead to a higher condensation in the vacuum chamber 200. However, by applying the direct vent according to present invention, it has been shown that the effect resulting from impurities caused by such condensation can be significantly reduced and even be avoided. As a consequence, so called “ghost peaks” resulting from such impurities and being measured in a chromatogram can either be reduced or even be eliminated.

1. A degassing apparatus (27) for degassing a liquid (240), the apparatus comprising:
a vacuum chamber (200),
a liquid conveyance member (210) disposed in the vacuum chamber (200) and adapted for transporting the liquid (240), and
a pump (220) adapted to evacuate the vacuum chamber (200),
wherein the vacuum chamber (200) comprises a vent (270) adapted for venting the vacuum chamber (200).

2. The degassing apparatus (27) of claim 1 or any of the above claims, wherein
the vent (270) comprises at least one of an orifice (290), a vent channel, a membrane, a tube, a capillary, a microstructure, and a microstructure with small holes.

3. The degassing apparatus (27) of claim 1 or any of the above claims, wherein
the vent (270) is designed so that a venting flow (275) through the vent (270) into the vacuum chamber (200) is adjusted to a pumping characteristic of the pump (220), so that the pump (220) can maintain a given vacuum level in the vacuum chamber (200).

4. The degassing apparatus (27) of claim 1 or any of the above claims, wherein
the vent (270) is configured to provide a venting flow (275) into the vacuum chamber (200) at a rate sufficient to prevent or at least reduce solvent condensation in the vacuum chamber (200) during operation of the degassing apparatus.

5. The degassing apparatus (27) of claim 1 or any of the above claims, wherein
the vent (270) comprises a filter (300) adapted for filtering a venting flow (275) through the vent (270) into the vacuum chamber (200).

6. The degassing apparatus (27) of the preceding claim, comprising at least one of:
the filter (300) is disposed at an inlet of the vent (270);
the filter (300) comprises a sintered porous frit;
the filter (300) comprises a sintered porous frit having a minimum pore size of about 10 μpm;
the filter (300) comprises at least one of an activated carbon, a membrane, a microstructure, and a sieve;
the filter (300) comprises a layered structure;
the filter (300) comprises a layered structure of two or more of: an activated carbon, a membrane, a microstructure, and a sieve;
the filter (300) is detachably coupled to the degassing apparatus;
the filter (300) is configured as a replaceable part allowing to replace one filter (300) by another;
the filter (300) comprises a replaceable filtering part for filtering the venting flow (275), so that one filtering part can be replaced by another.

7. The degassing apparatus (27) of claim 1 or any of the above claims, wherein
an outlet (290) of the vent (270) and a pump outlet (265) are situated into the vacuum chamber (200), wherein the pump (220) is coupled to the pump outlet (265) for evacuating the vacuum chamber (200).

8. The degassing apparatus (27) of the preceding claim, wherein
the outlet (290) of the vent (270) and the pump outlet (265) are situated at opposing or neighboring walls in the vacuum chamber (200).

9. The degassing apparatus (27) of the preceding claim, wherein
the outlet (290) of the vent (270) is situated adjacent to the pump (220) outlet.

10. The degassing apparatus (27) of claim 1 or any of the above claims, further comprising
a sensor (330) adapted to sense a value of pressure in the vacuum chamber (200).

11. The degassing apparatus (27) of claim 1 or any of the above claims, further comprising
a control unit (70) coupled to at least one of the vent (270) and the pump (220) and being adapted for controlling operation of at least one of the vent (270) and the pump (220).

12. The degassing apparatus (27) of the preceding claim, wherein
the control unit (70) is adapted for controlling a pressure in the vacuum chamber (200) by controlling operation of at least one of the vent (270) and the pump (220).

13. The degassing apparatus (27) of the preceding claim, wherein
the control unit (70) is adapted for controlling the pressure in the vacuum chamber (200) to be maintained at a given vacuum level.

14. The degassing apparatus (27) of claim 1 or any of the above claims, wherein
the liquid conveyance member (210) comprises a tubing (230) defining a lumen adapted for containing and transporting the liquid (240).

15. The degassing apparatus (27) of claim 1 or any of the above claims, wherein
the liquid conveyance member (210) comprises a cavity (350), adapted for containing and transporting the liquid (240), and a membrane (360) towards the vacuum chamber (200).

16. The degassing apparatus (27) of claim 1 or any of the above claims, wherein
a pressure in the evacuated vacuum chamber (200) is in the range 1-50 kPa and preferably about 10 kPa.

17. A fluid separation system (10) for separating compounds of a sample fluid in a mobile phase, the fluid separation system (10) comprising:
a mobile phase drive, preferably a pump (220)ing system, adapted to drive the mobile phase through the fluid separation system;
a degassing apparatus (27) of claim 1 or any one of the above claims for degassing the mobile phase; and
a separation unit, preferably a chromatographic column, adapted for separating compounds of the sample fluid in the mobile phase.

18. The fluid separation system (10) of the preceding claim, further comprising at least one of:
a sample injector adapted to introduce the sample fluid into the mobile phase;
a detector adapted to detect separated compounds of the sample fluid;
a collection unit adapted to collect separated compounds of the sample fluid;
a data processing unit adapted to process data received from the fluid separation system (10);
a flow cell adapted for guiding at least a portion of the stimulus signal through the mobile phase.

19. A method for degassing a liquid (240), comprising:
transporting the liquid (240) through a liquid conveyance member (210) disposed in an evacuated vacuum chamber (200), and
directly venting the vacuum chamber (200) through a vent (270) comprised in the vacuum chamber (200).

20. A software program or product, preferably stored on a data carrier, for controlling or executing the method of the preceding claim, when run on a data processing system such as a computer.
